(19) United States
(12) Patent Application Publication
(10) Pub. No.: US 2017/0030726 A1
(43) Pub. Date: Feb. 2, 2017

(54) SELECTIVE HUMAN EMOTION METRICS FOR NAVIGATION PLANS AND MAPS

(71) Applicant: International Business Machines Corporation, Armonk, NY (US)

(72) Inventors: Paul B. French, Cork (IE); Jack J. Healy, Carrigaline (IE)

(21) Appl. No.: 14/815,123

(22) Filed: Jul. 31, 2015

(51) Int. Cl. G01C 21/34

(52) U.S. Cl. CPC G01C 21/3461

(57) ABSTRACT

An enhanced navigation system allowing navigation route and destination planning according to user-specified criteria for the emotion state of persons along a route, at a destination, or both. The enhancement is accomplished by filtering a pool of users contributing human emotion metrics corresponding to one or more parts of a navigation plan to determine a subset of users who will be the best predictors of how an operator of the enhanced navigation system will respond emotionally to routes and destinations available for navigation. The human emotion metrics provided by the subset of users can be compared with an emotion objective to determine and provide suitable routes and destinations for navigation.

### BACKGROUND OF THE INVENTION

The present invention relates generally to Global Positioning System (GPS) based navigation systems and more specifically to GPS navigation systems based on selective human emotion metrics.

Navigation systems have become prolific in use by private citizens, corporations, government agencies and military units, in their vehicles, their cellular telephones, and even while walking. Many “stand alone” navigation systems are self-contained in that they contain a battery, a display (often touch-sensitive), an annunciator/speaker, an antenna for receiving a position indication signal and a processor with firmware for calculating a position, creating a display such as a map with icons, and determining a route with related parameters (length, time in route, estimated time of arrival, etc.).

### SUMMARY

According to an embodiment, a method for enhanced route and destination planning and navigation, the method comprising creating a reference table of a plurality of recently traveled route segments and destinations, and a first human emotion metrics corresponding to each of the plurality of recently traveled route segments and destinations, associated with a current user; receiving a second human emotion metrics for each user of a first group of users who have also recently traveled the route segments and destinations associated with the reference table; filtering the first group of users to generate a second group of “best predictor” users based on at least one of a predetermined threshold of similarities and a predetermined threshold of differences between the first human emotion metrics associated with the current user and each of the second human emotion metrics associated with each user of the first group of users; and generating an indicator of acceptability or unacceptability of an available destination and one or more associated route segments based on a correlation between a third human emotion metrics, associated with the second group of “best predictor” users, and an emotion objective for the available destination and one or more associated route segments selected by the current user. A corresponding computer program product and computer system are also disclosed herein.

### BRIEF DESCRIPTION OF THE DRAWINGS

FIG. 1A-C illustrates a key of example emoticons, an enhanced user interface display on a navigation system and a system design, respectively, in accordance with an embodiment of the present invention;

FIG. 2 provides an illustration of vehicle cabin enhancements for collecting and determining emotional data associated with a vehicle driver, in accordance with an embodiment of the present invention;

FIG. 3 illustrates a logical interaction of process components, in accordance with an embodiment of the present invention; and

FIG. 4 sets forth a generalized architecture of computing platforms suitable for at least one embodiment of the present invention.

### DETAILED DESCRIPTION

Some navigation systems are enhanced to take into account actual navigation data, such as delays, times of travel at specific times and days of the week, and temporary construction, which is reported to the provider of the navigation systems and updated or downloaded to the navigation systems. The route planning and navigation functions of the navigation systems can then take these additional “real world” factors into account when planning and proposing an actual route from point A to point B at a specific time on a specific day. However, as useful as these enhancements may be, there still exist significant events which can cause predicted travel times and delays to be inaccurate, which can lead to the user of the navigation system selecting a proposed route which is not optimal.

Recognizing this shortcoming, embodiments of the present invention described herein propose enhancements to navigation systems which allow the following user experience. Using a navigation-enabled smart phone or portable navigation device enhanced by embodiments of the present invention, the user chooses a destination and specifies a set of “emotion objectives” e.g., restaurant with happy people along a route devoid of angry people, for the route planning and optimization function of the navigation device. The enhanced navigation device then proposes to the user a prioritized set of routes and destinations based on the emotion-filtered input. If, during the walk, the user's emotion objectives are no longer being met, the enhanced navigation system can receive input from the user to update the route and/or destination choices based on the change in people's emotion along the route, at the destination or both.

Embodiments of the present invention differ from the prior art significantly because current navigation systems take into account such things as time to destination, traffic conditions, etc. in their routing algorithms, but do not take into account the emotions or other human characteristics of people present on the route(s) or at the destinations(s).

Therefore, second generation navigation systems or appropriately-capable computing devices enabled by embodiments of the present invention further improve quality of life and quality of experience for people traveling by foot, driving, boating, flying, sailing, etc.

For the purposes of the present disclosure, the emotional states of one or more persons along a route segment of travel or at a destination are referred to as “human emotion metrics,” which can include any emotion-related indicator about these persons, such as, but not limited to happy, sad, neutral, angry, frustrated, pleased, content, joyful, sorrowful, fearful, and hateful, for example. Additionally, there is both an aggregate aspect and a temporal aspect to the new process. The aggregate aspect involves determining the aggregate value of the emotion states (according to human emotion metrics) of people along the proposed route(s) or at the proposed destination(s) at a particular time, such as an aggregate value to determine if all people are happy now at a destination (e.g., is everyone happy at this club right now?), or an aggregate value to determine if all people were happy at a destination at a past date, day or time (e.g., did everyone enjoy themselves last night at this club?).

The temporal aspect of the present invention involves computing the temporal value of emotion of the same people for a period of time along the route and/or at the destination (e.g., have the people been happy or are they tending to be happier as they moved along a route or while they remained at a destination?).

Statistical computations on the aggregate and temporal values can optionally be included according to embodiments of the present invention, such as, but not limited to, calculating average values of human emotion metrics and standard deviations to indicate or examine the range of human emotion metrics being reported from a route segment or travel destination. Other calculations, such as derivatives of human emotion metrics over a period of time or across a sample set of people, can be used to determine changes in emotion states on a route or at a destination (first derivative, e.g., what is the difference or change in mood over a period of time or among a set of people), and the rate at which the change is occurring (e.g., is the mood slowly getting better or worse, and is the mood change accelerating?). Any number “N” of derivatives can be calculated and employed as they can be meaningful to interpreting the historical, current, static and dynamic natures of people who are traveling along a route, who are at a destination, or both.

The disclosure described herein refers to the “current user” of the logical process as the person operating a navigation-enabled computing device who is the recipient of the output of the process embodied by this invention, wherein the computing device can be, but is not limited to, a portable navigation system, another portable computing device (such as a cellphone), a web browser on a computer, or another application program.

In accordance with embodiments of the present invention (as described in detail later in this specification), further computations and processing can occur that filter the total pool of users contributing human emotion metrics data, for a given set of destinations and route segments, to a subset of those users who are the most likely (i.e., best matched) predictors of how the current user responds emotionally to a route segment and/or a destination. In this way, the route segments and/or destinations under consideration for navigation are based on the predicted emotional states of the current user (determined by similar users that are matched to the current user based on a comparison of historical mutual route reactions) and not on the current or historical mass consensus of users, which may not necessarily reflect the preferences of the current user.

In another aspect of potential embodiments according to the present invention, data from environmental sensors along the route(s) or at the destination(s) such as pollution sensors, ambient temperature sensors, and noise level sensors, are received by and used in the route planning and analysis function of a navigation system. These are ancillary to the objectives of the present invention because such conditions can cause people along each route or at each destination to trend towards being happier or sadder.

While the following disclosure will primarily focus on embodiments associated with navigation systems, those ordinarily skilled in the art will recognize that the present invention can well be realized in alternate embodiments with direction servers, such as online map services, as well as in alternate configurations in which a mobile client device receives mapping and/or navigation services from a communicatively connected directions server.

The inventive process set forth herein also can be applied just to destinations (for those who are not interested in a route to get to a destination), or to only portions of a route of navigation (i.e., route segments), or to combinations of destinations, way points, and route segments.

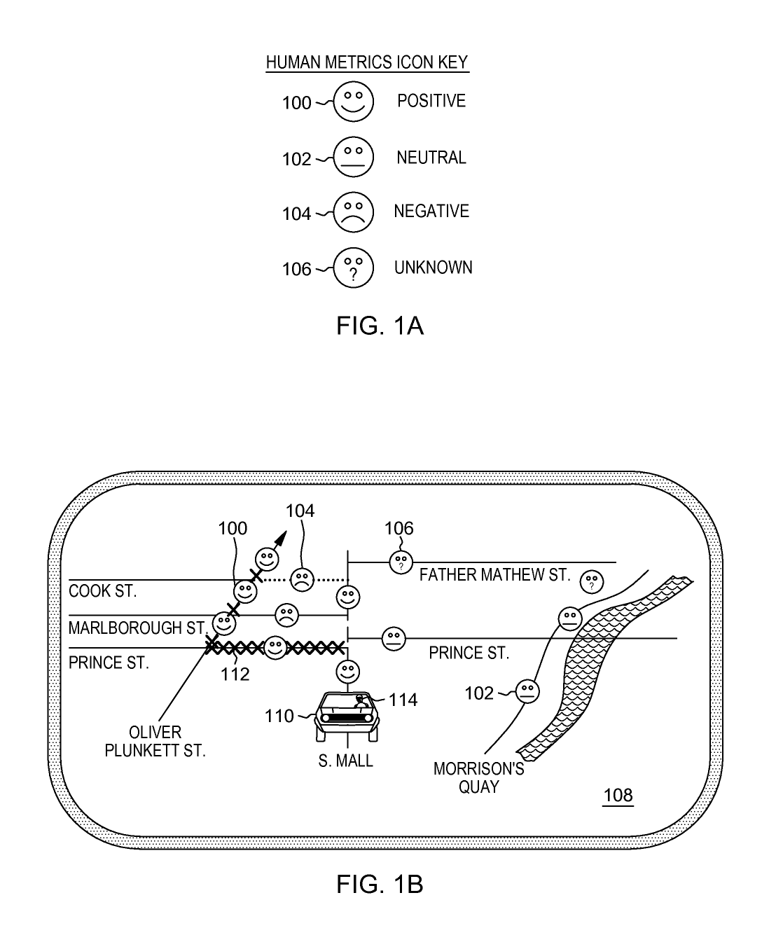

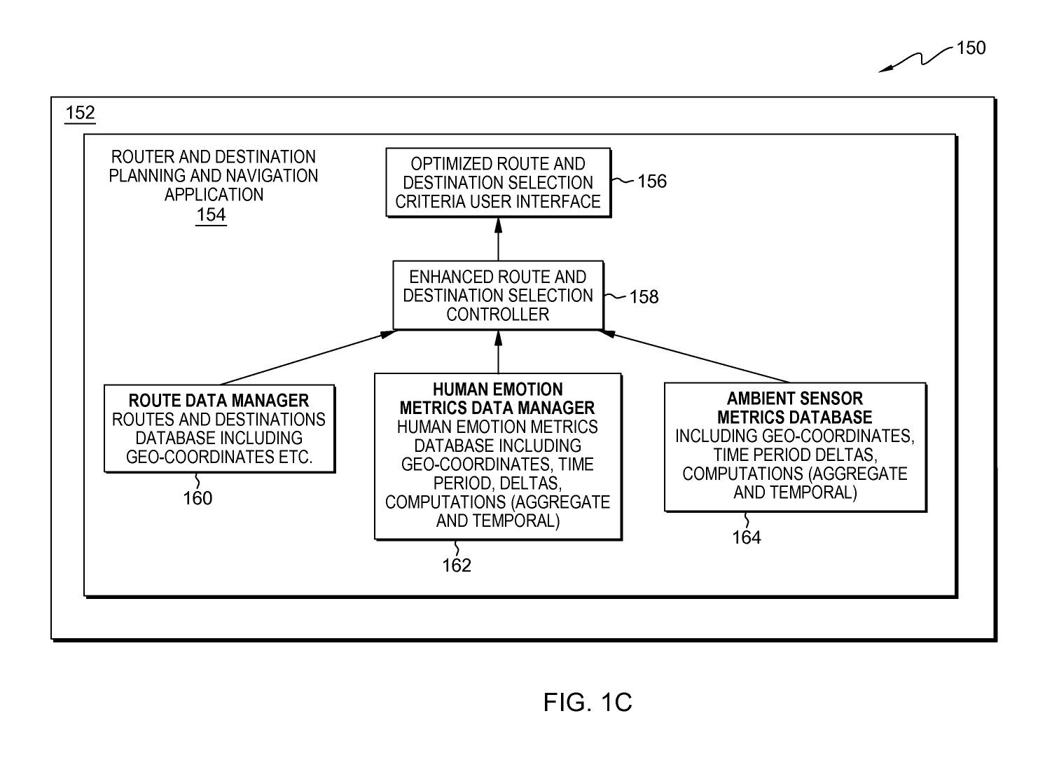

Turning to FIG. 1A, a set of exemplary emoticons are shown, one each for positive user emotions 100, neutral user emotions 102, negative user emotions 104 and unknown user emotions 106 to be overlaid on an enhanced display of a navigation system. FIG. 1B is an illustration of an enhanced user display 108 on a typical navigation system, wherein the display is enhanced to show emotion indicators, or “emoticons”, along the current path (represented as a dashed line). The current user's 114 location is indicated by the vehicle icon 110. In this example, users along the route up S. Mall Street appear to be currently (or historically) happy, but users along the segment traversing Cook Street appear to be currently (or historically) in a negative emotional state 104. Perhaps at this time of day there are often delays along this segment of the route. Continuing on the selected route, one can see that users are currently (or historically) happy 100 on Oliver Plunkett Street.

This enhanced user display 108 also shows user emoticons for possible alternative routes and route segments on the other streets, such as Marlborough, Prince, Cook, Father Mathew (which has unknown 106 emotional data, either currently or historically), and Morrison's Quay streets (which has neutral 102 emotional data, either currently or historically). According to one embodiment of the present invention, these additional emoticons will not be shown until (a) an unhappy condition is detected along the planned or selected route, or (b) upon the current user's 114 command to display the alternate route emoticons.

Subsequent to performing enhanced route planning and optimization to avoid route segments or destinations where users are currently or historically negative in emotions, a new route 112 has been determined (visible on enhanced user display 108) which proceeds up S. Mall Street until Prince Street, turns left at Prince Street and proceeds to Oliver Plunkett Street, turning right on Oliver Plunkett Street and proceeding to the synthetic horizon. As can be readily seen from this example, the current user 114 will arrive at the same point as the original route, but the route avoids the segments which are indicated by negative emoticons.

Referring to FIG. 1C, a system 150 according to an embodiment of the present invention is shown, in which the route and destination planning and navigation application 154 of a navigation-enabled computing device 152 is enhanced to include a human emotion metrics data manager 162 and optionally, an ambient sensor metrics database 164, cooperative with the normal route data manager 160. The enhanced route and destination selection controller 158 is configured to receive input from the human emotion metrics data manager 162 and optionally, ambient sensor metrics database 164, to be used in enhanced logical processes for selecting destination(s) and determining optimal routes. The user interface 156 is also enhanced to display the necessary user cues, such as, but not limited to, the emoticons 100, 102, 104, 106.

The following logical processes can be realized as part of embodiments according to the present invention through software or firmware programs added to an existing navigation system, or added to an appropriately-capable cellular telephone for example, or can be implemented in part or whole in customized circuitry.

Human emotion metrics can be received directly from persons at points of interests (POIs) or along segments of travel by some embodiments of the invention, wherein emotion or sentiment analysis is integrated into the same server computer with the logical processes of the present invention. In other embodiments according to the invention, emotion or sentiment analysis can be performed externally to the server computer implementing the present invention, such that human emotion analysis results are received and used by the new logical processes. In one manner of collecting human emotion metrics, persons at POIs or along route segments will manually enter their emotional dispositions (happy, sad, neutral, disappointed, angry, excited, confused, etc.), such as using a mobile phone or laptop computer to register their emotional state on a social web site (e.g., when “checking in”, etc.). A social web site sentiment analysis process such as that offered by Viralheat™ or other suitable processes (i.e., a human emotion metrics aggregation server) can then analyze the emotional dispositions of the users and process them according to keywords, phrases, and cluster analysis to generate human emotion metrics for points of interest and segments of travel. The resulting human emotion metrics can then be transmitted to a separate server performing the remaining logical processes of embodiments of the present invention in the case of externally-supplied human emotion metrics, or can be made available in storage memory to the remaining logical processes in the case of integrated human emotion metrics.

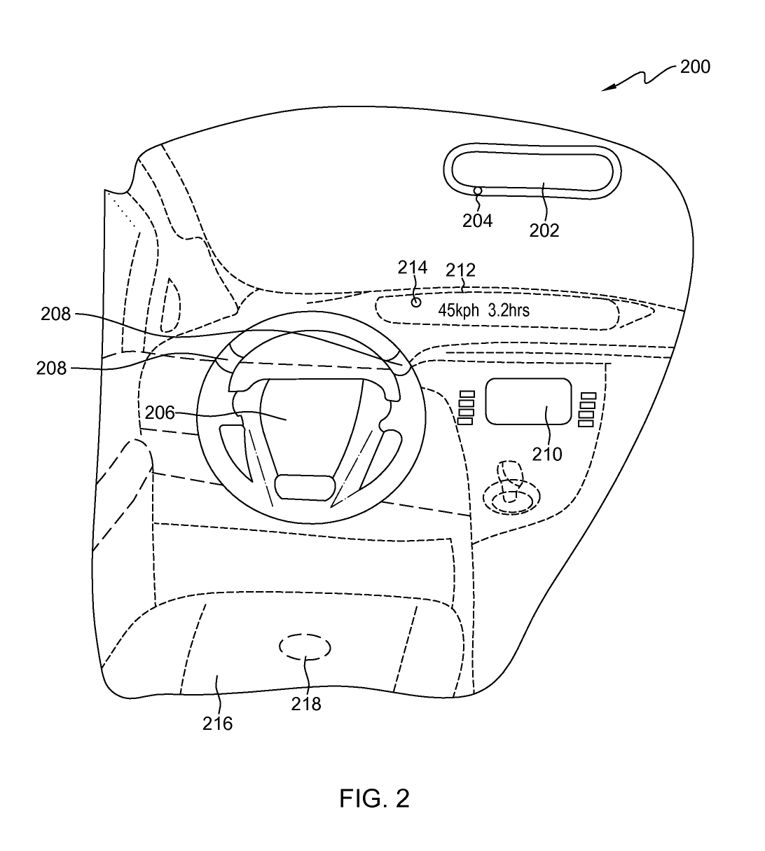

In another manner of collecting human emotion metrics, sensors can detect and determine the emotion states of persons at a destination, way point, or along a route segment and can present those metrics directly to an embodiment of the present invention or can process them prior to transferring them to an embodiment of the present invention. For example, FIG. 2 illustrates several proposed and/or readily available driver emotion sensors in a vehicle's cabin 200. For greater understanding of the invention, an example placement of an on-board (i.e., built-in) navigation system's screen 210 is shown in this figure.

The steering wheel 206 can be outfitted with one or more touch sensors 208 which can measure one or more of the following: a driver's pulse, a driver's grip strength and a driver's body temperature. A sensor 218 placed in the driver's seat 216 can collect similar data. This data can be correlated to a driver's emotion e.g., high driver temperature or high driver pulse can indicate unhappy or stressed condition, whereas lower driver temperature, lower driver pulse and lower driver grip strength can indicate relatively happier or neutral emotions.

Small cameras 214 and 204 can be placed in the cabin to view the driver's face, such as in the dashboard 212 or in the rearview mirror 202. Images from this camera can be analyzed by a processor associated with the vehicle or uploaded to a remote server for analysis to determine likely moods and emotions of the driver.

As previously mentioned, an available source of human emotion metrics, both real-time and historical, is the growing number of “social network” websites in which users upload photos and comments about their activities, such as, but not limited to, Facebook™, LinkedIn™, Spoke™, Twitter™, YouTube™, and Flickr™. As previously mentioned, there are presently automated services which can analyze the emotions or sentiments of users of these sites and provide data, statistics, and reports that can be received by embodiments of the present invention. For example, in these user's pages, accounts or profiles, a user will upload a photo and a text comment indicating that they are having a great time at a particular restaurant, or alternatively that they are bored or unsatisfied with the food or service. Image analysis can also be performed on the photo to determine the likely emotion status of one or more user's pictured in the image, such as detecting smiles or grimaces on faces in the image. Similarly, users may update their social network “pages” while stuck in traffic or delayed on a plane or train, that information also being available to be retrieved and aggregated to generate historical or current human emotion metrics for that particular destination or route. Further, messaging services can be used to ascertain emotional states of one or more users, such as analyzing messages (SMS, MMS), emails, “tweets”, bulletin board postings, blog entries and the like to find keywords and/or image indicators of emotional states and to generate human emotion metrics from this analysis. Advanced embodiments of the present invention can utilize combinations of externally-supplied human emotion metrics and internally-created human emotion metrics employing any combination of keyword analysis, phrase analysis, cluster analysis and image analysis on user comments, user annotations, emoticon selections, photographs (still images) and video clips.

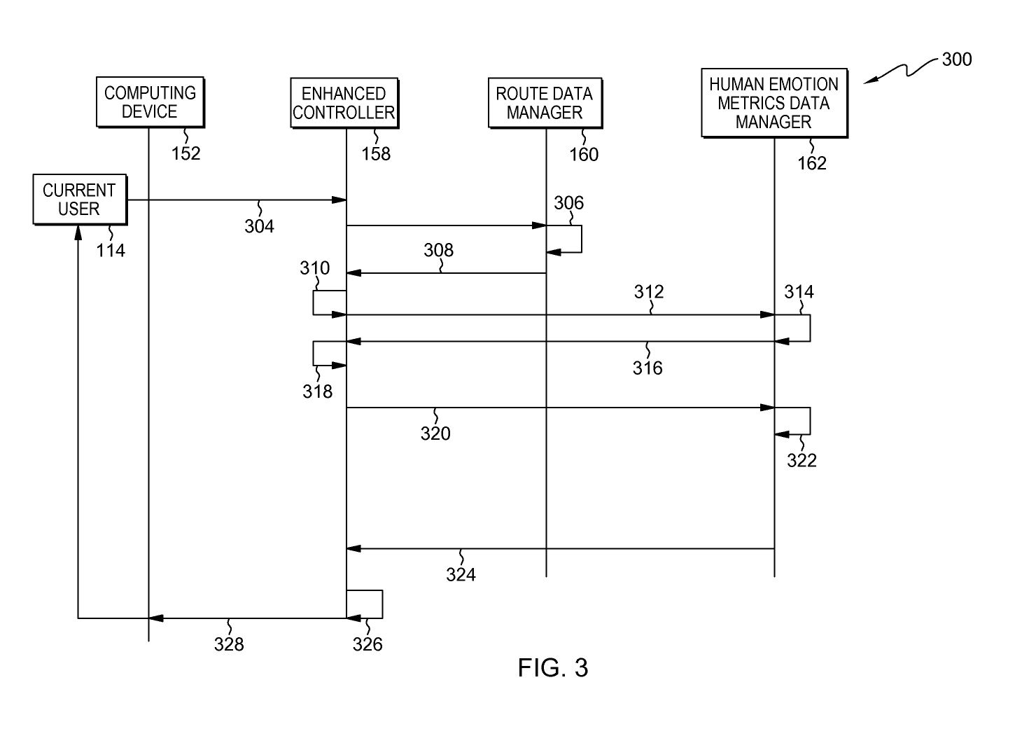

Turning to FIG. 3, the logical handling and analysis 300 of this human emotion metrics data is shown for at least one embodiment of the present invention. The current user 114 initiates a new route and destination planning operation with computing device 152 (with route and destination planning and navigation application 154), including providing one or more indications as to preferred emotions of persons along the route, at the destination, or both. The enhanced controller 158 receives 304 this information, including the new current user 114 preferences regarding emotion states of people currently and/or historically along the routes and/or at the destinations, and accesses the route data manager 160 to obtain 306 suitable routes and destinations data 308 which match the user's criteria for operation. Next, the enhanced controller 158 will determine (i.e., filter out) a subset of users who are the most likely predictors of the current user's 114 emotional reactions to routes and destinations, starting by creating 310 a reference table of a plurality of route segments and destinations recently traveled by the current user 114 and their emotional state or change in emotional state (i.e., human emotion metrics) for each of those recently traveled route segments or destinations. Enhanced controller 158 can then access 312 human emotion metrics data manager 162 which can identify 314 other users (i.e., a first group of users) who have also recently traveled those route segments or have been at those destinations on the aforementioned reference table and gather those other users' emotional states and/or changes in emotional state for those route segments and destinations. Receiving 316 this data back from human emotion metrics data manager 162, enhanced controller 158 now uses analytics to determine 318 which of those identified users (from the first group) had similar or opposite emotional states (or changes in emotional state) to the emotional states of the current user 114 for route segments or destinations recently traveled on the reference table. For example, according to one embodiment, if a certain user's emotional states either match or oppose (i.e., differ from) the current user's 114 emotional states for recently traveled route segments or destinations on the reference table according to a predetermined threshold (e.g., at least 75% of the time), that user is selected as what is referred to as a “best predictor” user for the current user 114. Once these “best predictor” users (i.e., a second group of users) have been identified, enhanced controller 158 accesses 320 human emotion metrics data manager 162 (and optionally the ambient sensor database [not shown]) again to obtain 322 current and/or historical human emotion metrics data of the “best predictor” users for available destinations and one or more associated route segments.

It should be noted that according to some embodiments, if a particular “best predictor” user had opposing emotional states compared with those of the current user 114 within the predetermined threshold for recently traveled routes and destinations, then the particular available destinations and one or more associated route segments that this particular “best predictor” user found enjoyable (i.e., responded favorably to) would indicate that the current user 114 would not enjoy these particular available destinations and one or more associated route segments. This is because the emotional states of this particular “best predictor” user for recently traveled routes and destinations have proven to be opposite to those of the current user 114. Furthermore, human emotion metrics of the “best predictor” users for available destinations and one or more associated route segments can be combined for better results (e.g., if for an available destination, one “best predictor” user, having similar emotional states to the current user 114 for recently traveled route segments and destinations, is happy at the available destination and another “best predictor” user, having opposite emotional states to the current user 114, is unhappy at the available destination, this combination of human emotion metrics is a strong indicator that the current user 114 will likely be happy at the available destination).

Receiving 324 this human emotion metrics data, enhanced controller 158 further optimizes 326 the routes and destinations data 308 (e.g., re-computes routes based on relevant human emotional metrics data received) and then generates an appropriate map annotated by the emotion indicators, such as emoticons, and provides 328 the enhanced map to the current user 114 via the user interface 156 of computing device 152.

It should be noted that at least one embodiment according to the present invention can allow for the current user 114 to set a variable threshold of emotional state similarity or dissimilarity for whether or not potential “best predictor” users are to be included in the group, e.g., the current user 114 sets as a requirement that in order for someone to be a “best predictor” user, their emotional states for recently traveled route segments or destinations on the reference table should match or oppose (i.e., differ from) that of the current user's 114 80% of the time.

In a further aspect according to one embodiment, the navigation system handles a case wherein a “best predictor” user for the current user 114 has not recently or ever been to an available destination and one or more associated route segments. This aspect involves the enhanced controller 158 looking for a route or destination recently taken by the “best predictor” user that is similar for example, but not limited to, demographically or topographically, within a predetermined similarity threshold to the available destination and one or more associated route segments by the current user 114 and using the “best predictor” user's emotional states for these similar routes and destinations as the human emotion metrics data corresponding to the available destination and one or more associated route segments. In this way, the “best predictor” users are still of use and value in the route and destination planning process notwithstanding the fact that the “best predictor” users have not provided human emotional metrics data directly related to the available destination and one or more associated route segments. To determine the similarity of available destination and one or more associated route segments to those recently traveled by “best predictor” users, enhanced controller 158 can access the route data manager 160 for topographical details of routes and destinations or access an internet-based service that can suggest or recommend routes and/or destinations similar to the ones being considered for navigation, for example. The foregoing examples are intended to be illustrative but not restrictive with regard to how enhanced controller 158 may find similar routes or destinations that “best predictor” users have recently traveled.

Subsequent to logical handling and analysis 300, if more than one route and/or destination met the current user's 114 criteria, then the current user 114 would select a destination, route, or both, and the route and/or destination would be “laid in” (e.g., locked into the map). After the route and destination are laid in, instructions, such as turn-by-turn instructions, are generated to the current user 114, positions are updated in real time, maps are refreshed, emoticons are refreshed and the current user 114 is directed along the route appropriately.

If, during navigation, updated human emotion metrics data is received 324, the route and destination analysis can be updated and the current user 114 alerted to a change in conditions. The current user 114 can elect to change the selection criteria, the route, the destination, or any combination of criteria, route and destination. After such a change, the logical handling and analysis 300 would be repeated to select a new route, a new destination, or both.

If during navigation, human emotion metrics data change to no longer meet the current user's 114 preferences, or if during planning of a destination or route segment no available destinations or route segments meets or exceeds the user's preferences, a “best fit” solution can be selected. A best fit solution in such a scenario can be determined by considering a degree of correlation between the human emotion metrics data and the current user's 114 preferences, optionally providing greater weight to certain preferences over others. For the purposes of this disclosure, the term “degree of correlation” is used to refer to how a human emotion metric compares to a user-specified criterion or preference (i.e., emotion objective) in degrees, rather than in absolutes, thereby allowing degrees of imprecision and precision, as in fuzzy logic theory. For example, the current user 114 will indicate that it is most important to find a restaurant destination where people are “happy” (specified in an absolute domain), and that finding a route where everyone along the route are happy is a lower priority preference. If no restaurants can be found where most diners are “happy” in an absolute sense, then the restaurant with the relatively “happiest” or even the “least sad” patrons can be selected or suggested.

The additional ambient sensor data (e.g., temperature, noise level, pollution, etc.) can be optionally incorporated into embodiments of the present invention and will be herein referred to in this specification as “ambient metrics.” As with the human emotion metrics data being received from an external source, so can the ambient metrics data be received from external sources. Current or historical values of ambient metrics can be used for route and destination planning purposes by embodiments of the present invention and can be used in combination with human emotion metrics data.

Further enhancements to the route and destination planning embodied by the present invention are to only use a subset of the human emotion metrics data that correspond to the available routes, destinations and time period. The subset can be based on matching the current user 114 of the navigation system and the details of the people who are on the route, e.g., matching their social background and education, living in the same area, age group, etc.

Further enhancements to the route and destination planning according to various embodiments can use a subset of the total human emotion metrics data related to the plans or objectives of the current user 114. These plans or objectives can be either manually entered by the current user 114 into the navigation system or can be inferred from a variety of sources, such as social media data (from a social media server), calendar and diary information on the navigation system or another device or server in communication with the navigation system. For example, the current user 114 can be planning to arrive at a movie theatre on time for a showing but could be held up by a street parade that they otherwise would have enjoyed, but in this case will cause a negative emotional state on the part of the current user 114 due to the parade delaying their plans. Therefore, the navigation system can determine users whose current or historical emotional states (or change in emotional states), corresponding to the available destinations and/or routes and time period being considered for navigation, will be most relevant to the current plans or objectives of the current user 114 (i.e., those user's plans and objectives can be considered to be matched with the plans or objectives of the current user 114).

Further enhancements according to some embodiments can include giving different weights to the human emotion metrics of people based on different criteria, e.g., give higher weight to people who live in the area, those with less than 80 mg of alcohol in their blood, etc. Other enhancements can also exist according to various embodiments by combining both the human emotion metrics and ambient metrics to produce higher level metrics representing the ‘best’ choice.

An enhanced route and/or destination selection criteria process of at least one embodiment according to the present invention, as a general example, comprises a navigation system performing the following steps: receive a destination selection and a set of emotion objectives related to people along the route and/or at the destination from a current user 114; determine the set of geo-coordinates corresponding to the routes (and contained route segments) and/or destinations; determine the time period corresponding to the request (e.g., now =last collection period, etc.); retrieve and compute the appropriate human emotion metrics (filtered for “best predictor users” as previously described) and differences (“deltas”) of the human emotion metrics related to the geo-coordinates of the routes (and contained route segments) and/or destinations and time period determined above; compute the aggregated values of human emotion metrics and deltas related to the geo-coordinates and time period selected above; compute temporal values of human emotion metrics and deltas related to the geo-coordinates and time period selected above; present the set of routes which satisfy the destination and emotion objectives to the current user 114; and present a user interface and application to compute and manage route and/or destination selection data. Current user 114 can choose an appropriate route and/or destination based on sorting, filtering and other mechanisms. Pre-determined options, such as those described later in this specification, are also available. Data presented to the current user 114 can include, but is not limited to, destination details (geo-coordinates, name), route details (geo-coordinates, name) that consist of a set of route segments and for each route segment a time period (time start, time end). The data can also include human values on a per-metrics basis (e.g., number of people and human emotional states such as happy, sad, etc. . . . ), where this data is aggregate (over all users) and/or temporal (based on individual users). The aggregate human value data can be an overall percentage of people at a certain emotional state during a period of time (e.g., over the last time period 75% (15 to 20 people) were happy) and the temporal human value data can be a percentage of people at a certain emotional state during a contiguous amount of time (e.g., over the last time period 50% (10 of 20 people) were continuously happy for 30 minutes). Similarly, the temporal data can be a percentage of people maintaining or improving in a certain emotional state during a contiguous amount of time (e.g., over the last time period 80% (16 of 20 people) were continuously happy or their mood improved for 30 minutes) and similar computations can be performed for “dis-improved” values.

The following, more detailed example of how to use an enhanced navigation system, or alternatively a mapping service, according to an embodiment of the present invention is presented in the following paragraphs for further illustration of the benefits. Such examples of use should not be construed to be limitations on the logical processes of embodiments of the present invention, nor should variations of user interface methods from those described herein be considered outside the scope of embodiments of the present invention.

In one embodiment, a current user 114 turns on a navigation system and types in a specific destination (restaurant by name, hotel by name, specific address, etc.) or enters destination search criteria (such as restaurant, hotel, nearby, near POI, etc.). The current user 114 is then presented a set of predetermined options relating to human emotion metrics. These can be specified on an aggregate basis (i.e., aggregate values of human emotion metrics of all people along the route), such as to select a route based on avoiding areas where people are or were angry, unhappy, anxious, etc., along the route to the destination, or selecting a route based on areas where people are or were happy, calm, etc., along the route, for example. Or, these human emotion metric criteria can be specified on a temporal basis (i.e., values of human emotion metrics of the same people who are traveling or have traveled along the route), such as to select a route based on avoiding areas where people were consistently angry, unhappy, anxious, or who got more angry (delta) along the route, or to select a route based on areas where people were consistently happy, calm or noisy, or who got progressively happier along the route.

Continuing with this example embodiment, the current user 114 is also presented the set of routes available and a list of aggregate or temporal values of human emotion metrics, such as a table of route options with human emotion (and optional ambient) metrics. This table can be sorted and filtered appropriately to give the “top n” (i.e., a plurality of) routes based on certain human emotion metrics, e.g., happiest first. This table can also display metrics currently known to the art, e.g., time to destination, etc. Sorting and filtering can be used to manage the list of routes.

Similar processes as described above in the foregoing example embodiment can also be realized where the current user 114 is offered the ability to choose a destination, e.g., restaurant, pub, based on these human emotion metrics (and optionally based on ambient sensor metrics).

As will be readily recognized by those skilled in the art, route planning and destination planning aspects of embodiments of the present invention can be realized and used separately or in combination with each other without departing from the spirit and scope of the invention.

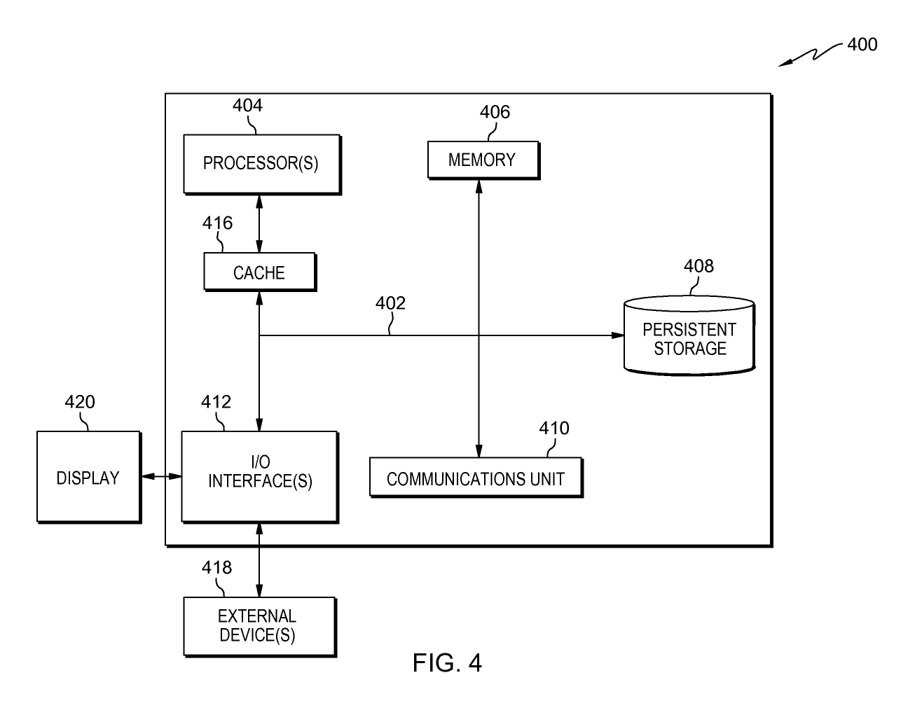

Turning to FIG. 4, a depiction of a block diagram of components of computing device 152 is presented, in accordance with an illustrative embodiment of the present invention. It should be appreciated that FIG. 4 provides only an illustration of one implementation and does not imply any limitations with regard to the environments in which different embodiments may be implemented. Many modifications to the depicted environment may be made.

Computing device 152 includes communications fabric 402, which provides communications between cache 416, computer processor(s) 404, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses or a crossbar switch.

Memory 406 and persistent storage 408 are computer readable storage media. In this embodiment, memory 406 includes random access memory (RAM). In general, memory 406 can include any suitable volatile or non-volatile computer readable storage media. Cache 416 is a fast memory that enhances the performance of computer processor(s) 404 by holding recently accessed data, and data near accessed data, from memory 406.

Route and destination planning and navigation application 154 can be stored in persistent storage 408 and in memory 406 for execution by one or more of the respective computer processors 404 via cache 416. In an embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer readable storage medium that is also part of persistent storage 408.

Communications unit 410, in these examples, provides for communications with other data processing systems or devices. In these examples, communications unit 410 includes one or more network interface cards. Communications unit 410 may provide communications through the use of either or both physical and wireless communications links. Route and destination planning and navigation application 154 may be downloaded to persistent storage 408 through communications unit 410.

I/O interface(s) 412 allows for input and output of data with other devices that may be connected to computing device 152. For example, I/O interface 412 may provide a connection to external devices 418 such as a keyboard, keypad, a touch screen, and/or some other suitable input device. External devices 418 can also include portable computer readable storage media such as, for example, thumb drives, portable optical or magnetic disks, and memory cards. Software and data used to practice embodiments of the present invention, e.g., route and destination planning and navigation application 154, can be stored on such portable computer readable storage media and can be loaded onto persistent storage 408 via I/O interface(s) 412. I/O interface(s) 412 also connect to a display 420.

Display 420 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for enhanced route and destination planning and navigation, the method comprising:
creating a reference table of a plurality of recently traveled route segments and destinations, and a first human emotion metrics corresponding to each of the plurality of recently traveled route segments and destinations, associated with a current user;
receiving a second human emotion metrics for each user of a first group of users who have also recently traveled the route segments and destinations associated with the reference table;
filtering the first group of users to generate a second group of “best predictor” users based on at least one of a predetermined threshold of similarities and a predetermined threshold of differences between the first human emotion metrics associated with the current user and each of the second human emotion metrics associated with each user of the first group of users; and
generating an indicator of acceptability or unacceptability of an available destination and one or more associated route segments based on a correlation between a third human emotion metrics, associated with the second group of “best predictor” users, and an emotion objective for the available destination and one or more associated route segments selected by the current user.

2. The method of claim 1, wherein the second human emotion metrics are received from at least one source selected from a group comprising a user's mobile device, a social web site server, a human emotion metrics aggregation server, a separate application program, a separate server and an emotion sensor.

3. The method of claim 1, wherein the current user operates a navigation-enabled computing device selected from a group comprising an on-board vehicle navigation system, a portable navigation system, a route and destination planning and navigation application operational on a computing device and a client device communicatively connected to a directions server.

4. The method of claim 1, further comprising updating the indicator of acceptability or unacceptability of the available destination and one or more associated route segments based on a received change in the third human emotion metrics.

5. The method of claim 1, wherein a fourth human emotion metrics based on at least one of a destination and route segments meeting a predetermined similarity threshold, associated with at least one of the “best predictor” users, are used when at least one of the “best predictor” users has not recently been to the available destination and traveled the one or more associated route segments.

6. The method of claim 1, further comprising:
filtering the second group of “best predictor” users based on matching a first set of plans and objectives associated with the current user to a second set of plans and objectives associated with the second group of “best predictor” users.

7. The method of claim 6, wherein the first and second set of plans and objectives are generated from a group comprising a social media server, manual entry of plans and objectives, calendar entries and diary entries.

8. A computer program product for enhanced route and destination planning and navigation, the computer program product comprising:
one or more computer readable storage media and program instructions stored on the one or more computer readable storage media, the program instructions comprising:
program instructions to create a reference table of a plurality of recently traveled route segments and destinations, and a first human emotion metrics corresponding to each of the plurality of recently traveled route segments and destinations, associated with a current user;
program instructions to receive a second human emotion metrics for each user of a first group of users who have also recently traveled the route segments and destinations associated with the reference table;
program instructions to filter the first group of users to generate a second group of “best predictor” users based on at least one of a predetermined threshold of similarities and a predetermined threshold of differences between the first human emotion metrics associated with the current user and each of the second human emotion metrics associated with each user of the first group of users; and
program instructions to generate an indicator of acceptability or unacceptability of an available destination and one or more associated route segments based on a correlation between a third human emotion metrics, associated with the second group of “best predictor” users, and an emotion objective for the available destination and one or more associated route segments selected by the current user.

9. The computer program product of claim 8, wherein the second human emotion metrics are received from at least one source selected from a group comprising a user's mobile device, a social web site server, a human emotion metrics aggregation server, a separate application program, a separate server, and an emotion sensor.

10. The computer program product of claim 8, wherein the current user operates a navigation-enabled computing device selected from a group comprising an on-board vehicle navigation system, a portable navigation system, a route and destination planning and navigation application operational on a computing device and a client device communicatively connected to a directions server.

11. The computer program product of claim 8, further comprising updating the indicator of acceptability or unacceptability of the available destination and one or more associated route segments based on a received change in the third human emotion metrics.

12. The computer program product of claim 8, wherein a fourth human emotion metrics based on at least one of a destination and route segments meeting a predetermined similarity threshold, associated with at least one of the “best predictor” users, are used when at least one of the “best predictor” users has not recently been to the available destination and traveled the one or more associated route segments.

13. The computer program product of claim 8, wherein the program instructions stored on the one or more computer readable storage media further comprise:
program instructions to filter the second group of “best predictor” users based on matching a first set of plans and objectives associated with the current user to a second set of plans and objectives associated with the second group of “best predictor” users.

14. The computer program product of claim 13, wherein the first and second set of plans and objectives are generated from a group comprising a social media server, manual entry of plans and objectives, calendar entries and diary entries.

15. A computer system for enhanced route and destination planning and navigation, the computer system comprising:
one or more computer processors;
one or more computer readable storage media;
program instructions stored on the one or more computer readable storage media for execution by at least one of the one or more processors, the program instructions comprising:
program instructions to create a reference table of a plurality of recently traveled route segments and destinations, and a first human emotion metrics corresponding to each of the plurality of recently traveled route segments and destinations, associated with a current user;
program instructions to receive a second human emotion metrics for each user of a first group of users who have also recently traveled the route segments and destinations associated with the reference table;
program instructions to filter the first group of users to generate a second group of “best predictor” users based on at least one of a predetermined threshold of similarities and a predetermined threshold of differences between the first human emotion metrics associated with the current user and each of the second human emotion metrics associated with each user of the first group of users; and
program instructions to generate an indicator of acceptability or unacceptability of an available destination and one or more associated route segments based on a correlation between a third human emotion metrics, associated with the second group of “best predictor” users, and an emotion objective for the available destination and one or more associated route segments selected by the current user.

16. The computer system of claim 15, wherein the second human emotion metrics are received from at least one source selected from a group comprising a user's mobile device, a social web site server, a human emotion metrics aggregation server, a separate application program, a separate server, and an emotion sensor.

17. The computer system of claim 15, wherein the current user operates a navigation-enabled computing device selected from a group comprising an on-board vehicle navigation system, a portable navigation system, a route and destination planning and navigation application operational on a computing device and a client device communicatively connected to a directions server.

18. The computer system of claim 15, further comprising updating the indicator of acceptability or unacceptability of the available destination and one or more associated route segments based on a received change in the third human emotion metrics.

19. The computer system of claim 15, wherein a fourth human emotion metrics based on at least one of a destination and route segments meeting a predetermined similarity threshold, associated with at least one of the “best predictor” users, are used when at least one of the “best predictor” users has not recently been to the available destination and traveled the one or more associated route segments.

20. The computer system of claim 15, wherein the program instructions stored on the one or more computer readable storage media further comprise:
program instructions to filter the second group of “best predictor” users based on matching a first set of plans and objectives associated with the current user to a second set of plans and objectives associated with the second group of “best predictor” users.
